(19) United States
(12) Patent Application Publication
(10) Pub. No.: US 2026/0021463 A1
(43) Pub. Date: Jan. 22, 2026

(54) METHOD AND DEVICE FOR ADJUSTING CHEMICALS IN HYDROCARBON TREATMENT

(71) Applicant: Birch Resources, LLC, Houston, TX (US)

(72) Inventor: Timothy Jacobs, Houston, TX (US)

(21) Appl. No.: 18/780,456

(22) Filed: Jul. 22, 2024

(51) Int. Cl. B01F 35/82; B01F 23/451; B01F 101/49

(52) U.S. Cl. CPC B01F 35/82; B01F 23/451; B01F 2101/49

(57) ABSTRACT

A method and system for adjusting chemicals in a fluid stream is disclosed. The method and system adjust the assumed concentration of a target substance in the fluid stream, and calculate a total amount of the target substance based on the flow rate. A chemical reagent stored in a tank is then introduced into the fluid stream at a injection rate sufficient to capture or otherwise remove the target substance from the fluid stream.

### PRIOR RELATED APPLICATIONS

Not applicable.

### FEDERALLY SPONSORED RESEARCH STATEMENT

Not applicable.

### FIELD OF THE DISCLOSURE

The disclosure generally relates to a method and system for adjusting a chemical reagent in a fluid stream to react with a target substance, and more particularly for adjusting the amount of a chemical reagent to be injected into a fluid stream based on a real-time measurement of the flow rate to calculate the amount of the target substance within the fluid stream.

### BACKGROUND OF THE DISCLOSURE

Hydrocarbons are important in modern life. However, the hydrocarbons produced from a reservoir are not pure and usually are accompanied by non-hydrocarbon contaminants that need to be filtered out or or captured before further processing. Exemplary contaminants include hydrogen sulfide (H₂S) and carbon dioxide (CO₂). When H₂S or CO₂ are produced as part of a hydrocarbon gas stream, such as metahne or ethane, the raw gas stream is sometimes referred to as the “sour gas,” and the H₂S and CO₂ are referred to as the “acid gases”.

In addition to hydrocarbon production streams, acid gases may be associated with synthesis gas streams, or with refinery gas streams. Acid gases may also be present within so-called flash-gas stream in gas processing facilities.

Hydrogen sulfide is a chemical of high grade of toxicity against humans and the environment. The formation of H2S in the hydrocarbon production/refinery process is undesirable because it prommotes corrosion and formation of the also undesirable SOx volatile species. Therefore, capturing and treating H₂S in the hydrocarbon production and refinery process is of high importance.

Currently there are various ways of removing hydrogen sulfide from a gas stream, including the use of chemical scanvengers, gas sweetening process, oxidation, solid bed absorption, and solvents. However, it is known in the field to first measure and calculate the amount of hydrogen sulfide that is present in the stream to be able to introduce sufficient amount of counter reagent to capture or otherwise remove H₂S from the gas stream. Such measurement of H₂S concentration can cause a delay in the H₂S capture operation, resulting in longer operation time and increase in operational cost. Additionally, the analyzer will need to be constantly calibrated or replaced, therefore further increases operation time and cost.

Therefore, there is the need for a method of removing unwanted chemicals in a fluid stream that is efficient and cost-effective.

### SUMMARY OF THE DISCLOSURE

To address the need, a method of adjusting composition in a fluid stream, the fluid stream comprising fluids from at least a first fluid source and a second fluid source, wherein the fluid stream having a target substance, the method comprising the steps of: measuring a first flow rate of the fluid from the first fluid source; measuring a second flow rate of the fluid from the second fluid source; calculating a combined amount of the target substance in the fluid stream based on the first flow rate and the second flow rate; and adjusting, optionally, an injection rate of a first chemical reagent into the fluid stream.

In another aspect of this disclosure, a method of adjusting composition in a fluid stream is disclosed, the liquid stream comprising fluids from at least a first fluid source and a second fluid source, and both fluid sources combine into a fluid stream having a target substance, the method comprising the steps of: measuring a flow rate of the combined fluid stream; measuring a concentration of the target substance in the combined fluid stream; and adjusting, optionally, an injection rate of a first chemical reagent into the fluid stream based on a calculation of the equivalent amount of the first chemical reagent necessary to react with the target substance.

In another aspect of this disclosure, a system of capturing a target substance in a fluid stream in a main pipeline, wherein the fluid stream comprises at least a first fluid source and a second fluid source, the system comprising: a first pipeline fluidically connecting the first fluid source to the main pipeline; a second pipeline fluidically connecting the second fluid source to the main pipeline; a first tank storing a first chemical reagent and fluidically connected to the main pipeline, wherein a pump is operatively connected to the first tank to controlls the first tank; a controller operatively coupled to the pump to control the actuation of the pump; at least one flow rate meter, wherein the flow rate meter is configured to measure the flow rate in the main pipeline or the flow rate in the first pipeline and the second pipeline; wherein the controller optionally actuates the pump, based on a calculatee concentration of a target substance in the fluid stream in the main pipeline, to inject the first chemical reagent from the first tank to the main pipeline, wherein the first chemical reagent reacts with the target substance.

In one embodiment, the method further comprises: measuring a first concentration of the target substance in the fluid from the first fluid source.

In one embodiment, the method further comprises: meausring a second concentration of the target substance in the fluid from the second fluid source.

In one embodiment, the fluid from the first fluid source having a first concentration of the target substance, and the fluid from the second fluid source having a second concentration of the target substance.

In one embodiment, the fluid from the first fluid source and the second fluid source are hydrocarbons, water or gaseous fluids.

In one embodiment, the first chemical reagent is injected into the fluid stream to react with the target substance in the fluid stream.

In one embodiment, the target substance is H₂S, NOₓ, SOₓ, CO, CO₂ or O₂.

In one embodiment, the first chemical reagent is MEA triazine, non-triazine scavengers, sodium hydroxide caustic scavengers, or sodium nitrate caustic scavengers.

In one embodiment, the step of “measuring a concentration of the target substance in the combined fluid stream” is performed periodically over a predetermined period of time.

In one embodiment, the step of “measuring a concentration of the target substance in the combined fluid stream” is performed in real time.

In one embodiment, the system further comprises a treating vessel fluidically connected to the main pipeline and the first tank, and wherein the first chemical reagent is introduced into the treating vessel to react with the target substance in the fluid stream.

In one embodiment, the first chemical reagent is introduced directly into the main pipeline to reacts with the target substance of the fluid stream.

In one embodiment, the system further comprises a first analyzer measuring concentration of the target substance.

In one embodiment, the first analyzer measures the concentration of the target substance in the main pipeline upstream of the injection of the first chemical reagent.

In one embodiment, the system further comprises a second analyzer measuring concentration of the target substance downstream of the inejction of the first chemical reagent.

In one embodiment, the system further comprises a second tank storing a second chemical and fluidically connected to the main pipeline.

In one embodiment, the calculated concentration of the target substance is calculated by a programmable logic controller (PLC) or a supervisory control and data acquisition (SCADA).

As used herein, “fluid stream” means a stream of fluid flowing inside a pipeline. The fluid can be liquid or gaseous.

As used herein, “target substance” refers to an element, a chemcial or a compound that is present in the fluid stream that may be captured or otherwise removed to improve the quality of the fluid strem.

As used herein, “analyzer” refers to a device for measuring the concentration of a specific substance. For example, for H₂S Dräger gas detection tubes are used. Draeger gas detection tubes are colorimetric gas detection tubes that are used to identify and detect different substances. They consist of glass vials filled with a chemical reagent that reacts to a specific substance or a family of substances. In use, one end of the tube is snipped and placed into a Drager-tube pump and draw the gas-of-interest through the Grager tube. If the specific substance is present in the gas stream, the tube will change colors, thereby measuring the concentration present. For liquid phase stream, preferablly samples are taken and and sent to a lab for analysis. However, other analyzers are also available without deviating from this disclosure.

As used herein, “flow rate” refers to the quantity of fluid that is passing through a cross-section of a pipe in a specific period of time. It can refer to volumetric flow rate or mass flow rate.

As used herein, “injection rate” refers to the rate at which the chemical reagent being introduced into the fluid stream. It is to be noted that the “injection rate” is different from “dosage rate,” which is provided by the provider of the chemical reagent. Dosage rate is typically treated as a baseline reference, and the actual injection rate is to be adjusted by the method of this disclosure. In actual field applications, different variables may affect the effectiveness of the chemical reaction in the fluid stream, and therefore an additional adjustment for efficiency may be applied by the operator to account for the efficiency changes.

As used herein, “controller” refers to a computer or server capable of executing predetermined function, such as calculating the amount of a substance based on the flow rate and concentration within the fluid stream, as well as calculating a corresponding dosage rate to be injected. The controller need not be physically adjacent to the system or the pump/tank. Instand, the controller can be operatively connected to the system or pump/tank through wire or wireless connection.

As used herein, a programmable logic controller (PLC) refers to a specialized computer designed for industrial automation and control. PLCs can manage and control various processes, including manufacturing, assembly lines, and material handling systems. A typical PLC system consists of several essential components that work together to execute control tasks, including a processor, a memory, input/output modules, a power supply, communication interfaces, and a programming device. The processor is the brain of the PLC, responsible for executing the control program stored in its memory. PLCs often have communication interfaces to connect with other devices, such as human-machine interfaces (HMIs), other PLCs, or remote I/O modules. A programming device, such as a personal computer or a dedicated handheld programmer, is used to create, modify, and troubleshoot the control program for the PLC.

As used herein, supvervisory control and data acquisition (SCADA) refers to a combination of software and hardware components that work together to monitor and control industrial processes. They are used to monitor and control large-scale industrial processes, such as power generation, water treatment, and manufacturing. A typical SCADA system consists of several key components that work together to collect, process, and display data from various devices and processes, including: sensors and actuators, SCADA field controllers, SCADA master stations, human-machine interface (HMI), communicatino network, data storage, and an alarm and event management system.

As used herein, “pump controller” refers to a device that cycles the pump on/off or adjusts the hertz on the motor to achieve a specific Injection rate

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

### BRIEF DESCRIPTION OF THE DRAWINGS

FIG. 1. A schematic view of an example of a system of this disclosure.

FIG. 2. A schematic view of an alternative example of a system of this disclosure.

FIG. 3. A schematic view of another alternative example of a systemm of this disclosure.

FIG. 4. A schematic view of yet another alternative example of a system of this disclosure.

FIG. 5A-G. Screenshot of a software executing the method of this disclsoure.

FIG. 6. A comparison of the amount of chemical reagent according to conventional method and the present disclosure.

### DETAILED DESCRIPTION

The disclosure provides novel method and system for effectively measuring and calculating the overall concentration of a target substance in a fluid stream that is combined from two or more fluid sources, thereby allowing real-time adjustment of an injection rate of a first chemical reagent into the fluid stream. This is accomplished by assuming the concentration of the target substance in each fluid source remaining constant within a period of time, for example between two scheduled measurements of concentration, so as to bypass the constant need to first measure the concentration before calculating the combined concentration in the fluid stream.

The number of fluid sources may vary, but as long as the concentration of the target substance remains constant in each of the fluid source, the combined concentration can be calculated by measuring only the real-time flow rate in each of the fluid source. This reduces the time required for calculating the combined concentration, because the step of measuring concentration is the time-consuming step.

The type of fluid being transmitted, measured and calculated may require minor adjustment in parameters, but the overall methodology is the same, i.e. to assume the concentration of the target substance remains constant in a given fluid source. This has been the inventor's finding that, although the concentration may fluctuate in a short period of time, it can be considered constant over a prolonged period of time (data not shown). This enables the elimination of constantly measuring the concentration, thereby saving time and money for the operation.

While the method and system of this disclosure is primarily directed to hydrocarbons and the removal of H₂S or CO₂, the same methodology is applicable to other fluid stream and target substances, as long as the concentration of the target substance in the fluid stream remains relatively constant from different source fluids. This is especially the case when each of the fluid sources have exhibited stable concentration of the target substance for a long period of time. For example, the method and system of this disclosure can also be applied to calculating the concentration of carbon dioxide (CO₂) in hydrocarbon production wells.

Other applications may include water treatment, where various impurities in water may be captured and removed therefrom according to the method and system of this disclsoure.

One important aspect of the method and system of this disclosure is the real-time measurement of flow rate for each fluid source, or the real-time flow rate of the combined fluid stream. This can be accomplished by flow meters known in the art. A flow meter, sometimes referred to as a flow sensor, is a flow instrument that is used to indicate the amount of liquid, gas or vapor moving through a pipe or conduit by measuring linear, non-linear, mass, or volumetric flow rates. Non-limiting flow meters include differential pressure flow meters, orifice flow meters, venturi flow meters, Pitot tubes, positive displacement flow meters, reciprocating piston meters, oval-gear meters, nutating-disk meters, rotary vane meters, helix flow meters, volumetric flow meters, turbine flow meters, magnetic flow meters, coriolis flow meters, mass flow meters, ultrasonic flow meters, vortex meters, turbine flow meters, multiphase meters, rotameters, etc.

A differential pressure flow meter measures the differential pressure as an inferred measurement of a fluid's flow rate, and is most commonly used. It calculates fluid flow by reading pressure loss across a pipe restriction. The basic operating principle of differential pressure flow meters is based on the premise that the pressure drop across the meter is proportional to the square of the flow rate. The flow rate is obtained by measuring the pressure differential and extracting the square root. Differential pressure flow meters have a primary and secondary element. The primary element causes a change in kinetic energy, which creates the differential pressure in the pipe. The unit must be properly matched to the pipe size, flow conditions, and the liquid's properties. And, the measurement accuracy of the element must be good over a reasonable range. The secondary element measures the differential pressure and provides the signal or read-out that is converted to the actual flow value.

Orifice flow meters are the most popular liquid flow meters in use today. An orifice is simply a flat piece of metal with a specific-sized hole bored in it. Most orifices in use are of the concentric type, but eccentric, conical (quadrant), and segmental designs are also available. In practice, the orifice plate is installed in the pipe between two flanges. Acting as the primary device, the orifice constricts the flow of liquid to produce a differential pressure across the plate. Pressure taps on either side of the plate are used to detect the difference. Major advantages of orifices are that they have no moving parts, and their cost does not increase significantly with pipe size.

Conical and quadrant orifices are relatively new. The units were developed primarily to measure liquids with low Reynolds numbers. Essentially constant flow coefficients can be maintained at R values below 5000. Conical orifice plates have an upstream bevel, the depth and angle of which must be calculated and machined for each application. The segmental wedge is a variation of the segmental orifice. It is a restriction orifice primarily designed to measure the flow of liquids containing solids. The unit has the ability to measure flows at low Reynolds numbers and still maintain the desired square-root relationship. Its design is simple, and there is only one critical dimension the wedge gap. Pressure drop through the unit is only about half that of conventional orifices.

Integral wedge assemblies combine the wedge element and pressure taps into a one-piece pipe coupling bolted to a conventional pressure transmitter. No special piping or fittings are needed to install the device in a pipeline. Metering accuracy of all orifice flowmeters depends on the installation conditions, the orifice area ratio, and the physical properties of the liquid being measured.

Venturi flow meters have the advantage of being able to handle large flow volumes at low pressure drops. A venturi tube is essentially a section of pipe with a tapered entrance and a straight throat. As liquid passes through the throat, its velocity increases, causing a pressure differential between the inlet and outlet regions. The flowmeters have no moving parts. They can be installed in large diameter pipes using flanged, welded or threaded-end fittings. Four or more pressure taps are usually installed with the unit to average the measured pressure. Venturi tubes can be used with most liquids, including those having a high solids content.

Pitot tubes are generally installed by welding a coupling on a pipe and inserting the probe through the coupling. Use of most pitot tubes is limited to single point measurements. The units are susceptible to plugging by foreign material in the liquid. Advantages of pitot tubes are low cost, absence of moving parts, easy installation, and minimum pressure drop.

Positive displacement flow meters separate liquids into accurately measured increments and moving them on. ach segment is counted by a connecting register. Because every increment represents a discrete volume, positive-displacement units are popular for automatic batching and accounting applications. Positive-displacement meters are good candidates for measuring the flows of viscous liquids or for use where a simple mechanical meter system is needed.

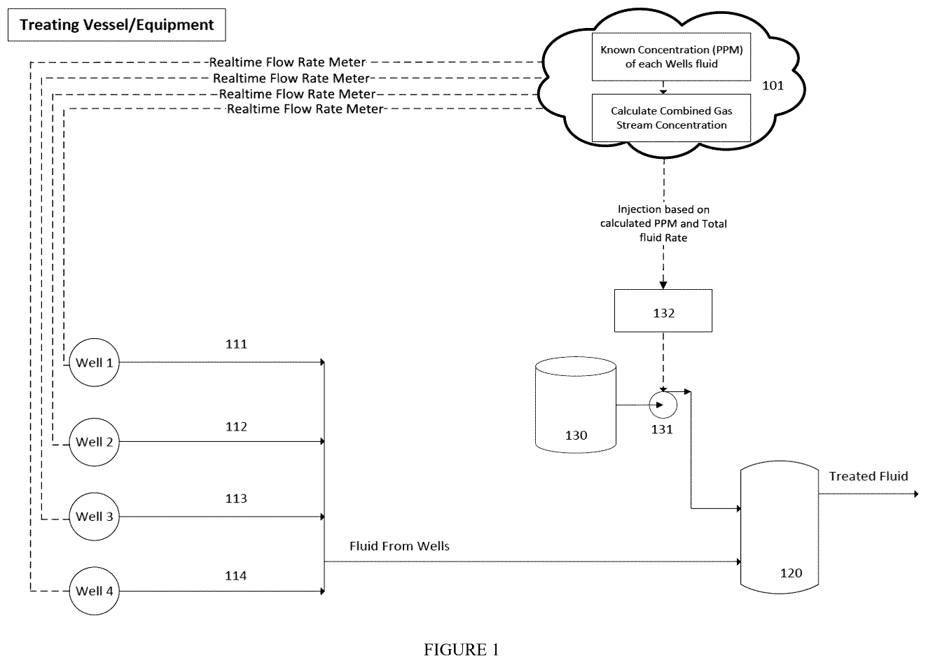

Reciprocating piston meters are of the single and multiple-piston types. The specific choice depends on the range of flow rates required in the particular application. Piston meters can be used to handle a wide variety of liquids. A magnetically driven, oscillating piston meter is shown in FIG. 1. Liquid never comes in contact with gears or other parts that might clog or corrode.

Oval-gear meters have two rotating, oval-shaped gears with synchronized, close fitting teeth. A fixed quantity of liquid passes through the meter for each revolution. Shaft rotation can be monitored to obtain specific flow rates.

Nutating-disk meters have a moveable disk mounted on a concentric sphere located in a spherical side-walled chamber. The pressure of the liquid passing through the measuring chamber causes the disk to rock in a circulating path without rotating about its own axis. It is the only moving part in the measuring chamber. A pin extending perpendicularly from the disk is connected to a mechanical counter that monitors the disk's rocking motions. Each cycle is proportional to a specific quantity of flow. As is true with all positive-displacement meters, viscosity variations below a given threshold will affect measuring accuracies. Many sizes and capacities are available. The units can be made from a wide selection of construction materials.

Rotary-vane meters are available in several designs, but they all operate on the same principle. The basic unit consists of an equally divided, rotating impeller (containing two or more compartments) mounted inside the meter's housing. The impeller is in continuous contact with the casing. A fixed volume of liquid is swept to the meter's outlet from each compartment as the impeller rotates. The revolutions of the impeller are counted and registered in volumetric units.

Helix flow meters consist of two radically pitched helical rotors geared together, with a small clearance between the rotors and the casing. The two rotors displace liquid axially from one end of the chamber to the other.

Volumetric flow meters operate linearly with respect to the volume flow rate. Because there is no square-root relationship (as with differential pressure devices), their rangeability is greater. Volumetric meters have minimum sensitivity to viscosity changes when used at Reynolds numbers above 10,000. Most velocity-type meter housings are equipped with flanges or fittings to permit them to be connected directly into pipelines.

Turbine flow meters are widely used for accurate liquid mesurement applications. The unit consists of a multiple-bladed rotor mounted with a pipe, perpendicular to the liquid flow. The rotor spins as the liquid passes through the blades. The rotational speed is a direct function of flow rate and can be sensed by magnetic pick-up, photoelectric cell, or gears. Electrical pulses can be counted and totalized. The number of electrical pulses counted for a given period of time is directly proportional to flow volume. A tachometer can be added to measure the turbine's rotational speed and to determine the liquid flow rate. Turbine meters, when properly specified and installed, have good accuracy, particularly with low-viscosity liquids.

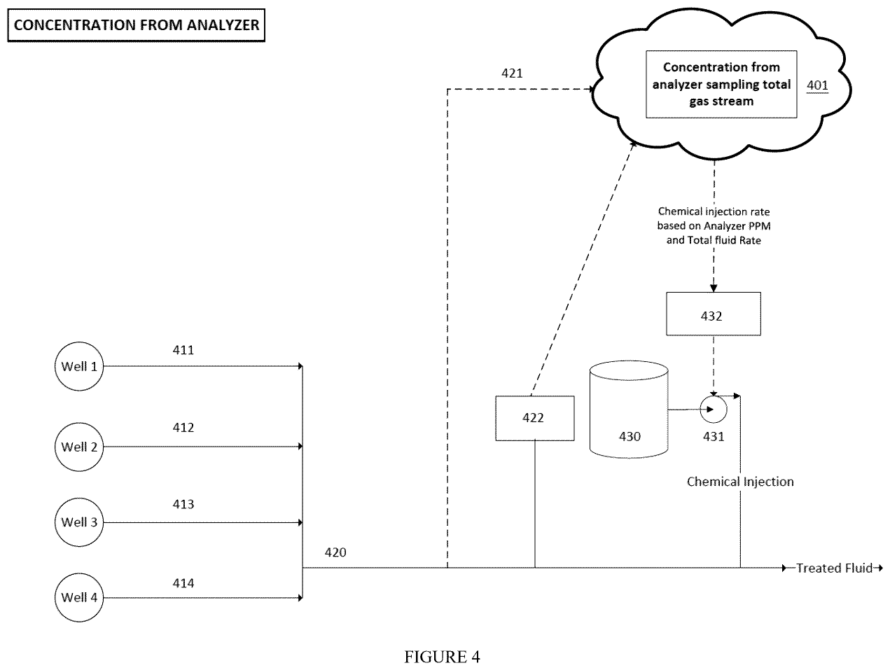

Vortex flow meters make use of a natural phenomenon that occurs when a liquid flows around a bluff object. Eddies or vortices are shed alternately downstream of the object. The frequency of the vortex shedding is directly proportional to the velocity of the liquid flowing through the meter. The three major components of the flowmeter are a bluff body strut-mounted across the flowmeter bore, a sensor to detect the presence of the vortex and to generate an electrical impulse, and a signal amplification and conditioning transmitter whose output is proportional to the flow rate, FIG. 4. The meter is equally suitable for flow rate or flow totalization measurements. Use for slurries or high viscosity liquids is not recommended.

Electromagnetic flow meters can handle most liquids and slurries, providing that the material being metered is electrically conductive. The flow tube mounts directly in the pipe. Pressure drop across the meter is the same as it is through an equivalent length of pipe because there are no moving parts or obstructions to the flow. The voltmeter can be attached directly to the flow tube or can be mounted remotely and connected to it by a shielded cable. Electromagnetic flow meters operate on Faraday's law of electromagnetic induction that states that a voltage will be induced when a conductor moves through a magnetic field. The liquid serves as the conductor; the magnetic field is created by energized coils outside the flow tube. The amount of voltage produced is directly proportional to the flow rate. Two electrodes mounted in the pipe wall detect the voltage, which is measured by the secondary element.

Ultrasonic flow meters can be divided into Doppler meters and Time-of-Travel (or Transit) meters. Doppler meters measure the frequency shifts caused by liquid flow. Two transducers are mounted in a case attached to one side of the pipe. A signal of known frequency is sent into the liquid to be measured. Solids, bubbles, or any discontinuity in the liquid, cause the pulse to be reflected to the receiver element. Because the liquid causing the reflection is moving, the frequency of the returned pulse is shifted. The frequency shift is proportional to the liquid's velocity.

Mass flow meters include the Coriloils mass flow meter, which is based on the natural phenomenon called the Coriolis force. Coriolis flow meters measure the mass rate of flow directly as opposed to volumetric flow. Because mass does not change, the meter is linear without having to be adjusted for variations in liquid properties. It also eliminates the need to compensate for changing temperature and pressure conditions. The meter is especially useful for measuring liquids whose viscosity varies with velocity at given temperatures and pressures. Coriolis flow meters are true mass meters that measure the mass rate of flow directly as opposed to volumetric flow. Because mass does not change, the meter is linear without having to be adjusted for variations in liquid properties. It also eliminates the need to compensate for changing temperature and pressure conditions. The meter is especially useful for measuring liquids whose viscosity varies with velocity at given temperatures and pressures.

Measuring the concentration of the target substance in the fluid sources is an optional step, and may require different equipment. Concentration measurement can be achieved in a number of ways. A spectrophotometer measures the absorbance of light by a solution at a specific wavelength, and the concentration of the solution can be determined from the relationship between absorbance and concentration according to Beer's Law. A refractometer measures the refractive index of a solution to determine its concentration. Conductivity meters and pH meters can indirectly measure the concentration of certain types of solutions. Gravimetric analysis involves percipitating of a species of interest from a solution and weighing the precipitate to determine its mass.

In one embodiment, the target substance is hydrogen sulfide, and the first chemical reagent that is used to capture hydrogen sulfide is MEA triazine, non-triazine scavengers, sodium hydroxide caustic scavengers, sodium nitrate caustic scavengers, or combinations thereof.

Hydrogen sulfide can be measured a variety of methods due to sulfur's versatile chemistry. The Occupational Safety and Health Administration (OSHA) uses air grab samples where hydrogen sulfide sorbs onto or reacts with chemicals in the sampling apparatus. Then in the lab sulfur is released through oxidation, and the sulfate ion that is produced is analyzed throgh ion chromatography and conductivity measurement, as detailed in OSHA method 1008.

The Environmental Protection AGency (EPA) uses several aliquots from in-line sampling, where the compounds in the sample stream are separated by gas chromatography, and then the hydrogen sulfide is measured by dimerizing to S2 gas, exciting it, and then monitoring the relaxation emissions at a specific wavelength (394 nm), as detailed in EPA Method 15.

Other field measurements of H2S may include colorimetric measurement, electrochemical measurement, anodic stripping voltammetry, etc. Colorimetric assays use a colorimeter (spectrophotometer) to determine concetration of a chemical compound in a solution by measuring spectral absorbance of the compound at a particular wavelength. For example, Gastec hydrogen sulfide detection tubes or the Matheson-Kitagawa hydrogen sulfide detection tubes may be used.

Electrochemical sensors are more costly with improved precision, for example the Jerome sensor, which is an handheld device that offers measurement within 30 seconds of sampling. It monitors the electrical resistance throught a gold film inside it, where the hydrogen sulfied with react with the gold film to form gold sulfide that is less conductive than pure gold. The sensor register that change in resistance in proportion of gold sulfide, which is then used to calculate the concentration of hydrogen sulfide in the sampled air.

Many airborne chemical measurements are made by collecting a “grab sample” (please see here for more information about different types of sampling) and then analyzing that sample in the laboratory. One laboratory method in development for analyzing hydrogen sulfide at relatively low cost is through anodic strippingn voltammetry (ASV) using a DIY potentiostat. The low-cost ASV method for hydrogen sulfide determination involves introducing air into a copper solution and monitoring the cupric oxide formed, returning the solution, and then introducing hydrogen sulfide into the system and comparing the cuprous oxide (Cu₂O) and the cuprous sulfide (Cu₂S) that form.

Flow rate in the pipeline is measured using different technologies without deviating from the instant disclosure. For example, acoustic meters, magnetic meters, and venturi meters with flow recorders can be used for measuring flow rates. Acoustic meters are versatile and can be used inside pressured pipes, in partially filled pipes, or in open channels. Acoustic meters can also be mounted externally on plastic pipes.

The present invention is exemplified using H₂S in produced hydrocarbons. However, this is exemplary only, and the invention can be broadly applied to any fluid stream, liquid or gas, as long as the target substance in the fluid stream maintains relatively constant. The following examples are intended to be illustrative only, and not unduly limit the scope of the appended claims.

### Example 1

### Measuring Real-Time Flow Rate of Four Fluid Sources

Please refer to FIG. 1, where there are four fluid sources 111, 112, 113, 114 produced from four different wells 1-4, each containing different H2S concentration and different flow rate. The four fluid sources 111, 112, 113, 114 in this example converges at a bubble tower or a comingled vessel 120. A chemical tank that stores a H2S scavenger is fluidly connected to the bubble tower 120 through a pump 131, and the pump 131 is in turn controlled by a chemical pump actuator 132.

At the wellpad of wells 1-4, each is equiped with a flow rate meter to provide real-time flow rate of each fluid sources 111, 112,113,114 to a controller 101. Here at the controller 101, assuming the concentration of H₂S in the produced hydrocarbons each well remains constant, a combined gas stream concentration can be calculated. Based on the combined gas stream concentration, the controller 101 then calculates the amount of H₂S scavenger necessary to capture the H₂S in the combined gas stream, and thereby controls the chemical pump actuator 132 to introduce the required amount of H₂S scavenber into the bubble tower 120 through the pump 131. After reacting for a predetermined period of time, the treated fluid can be transmitted to the next processing unit. As discussed herein, the predetermined period of time generally refers to the time for fluid to enter and exit the vessel, and that may be regulated by an upstream pressure regulator or a bak pressure valve (BPV) to either speed up or slow down the flow based on real-time vessel pressure. The method and system effectively eliminates the need to measure the H₂S concentration in the produced hydrocarbon before determining the amount of H₂S scavenger to be added, which is the time-consuming step that causes the operation to halt. Additionally, the analyzer that measures the H2S concentration in the produced hydrocarbon needs constant calibration to provide accurate readings. If the reading is higher than the actual H2S concentration, too much H2S scavenger By eliminating the step of H₂S concentration measurement, the H₂S removal process can be operated continuously without interruption, thereby improving the efficiency and reducing operational cost.

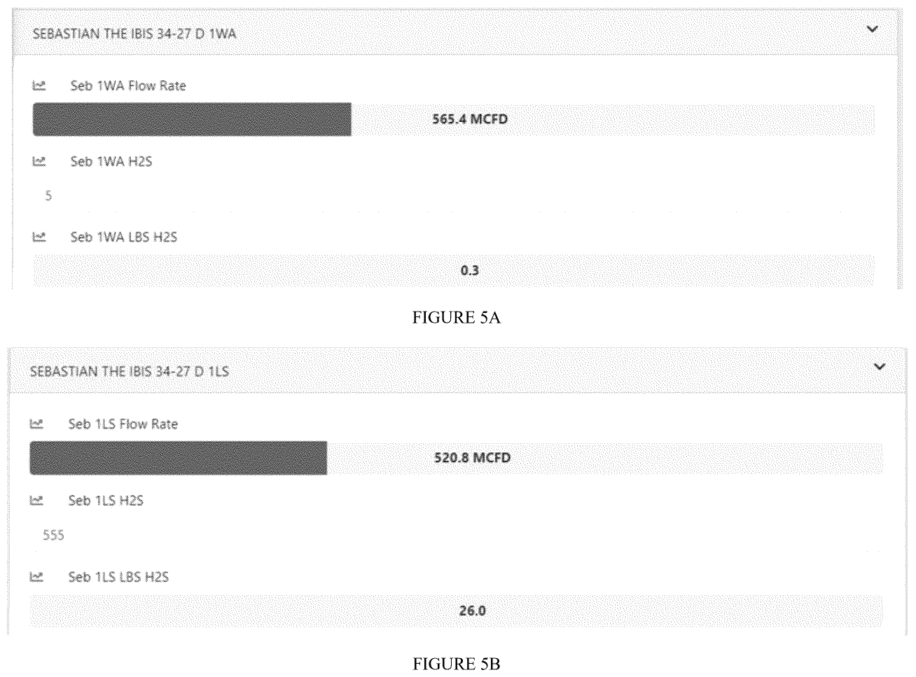

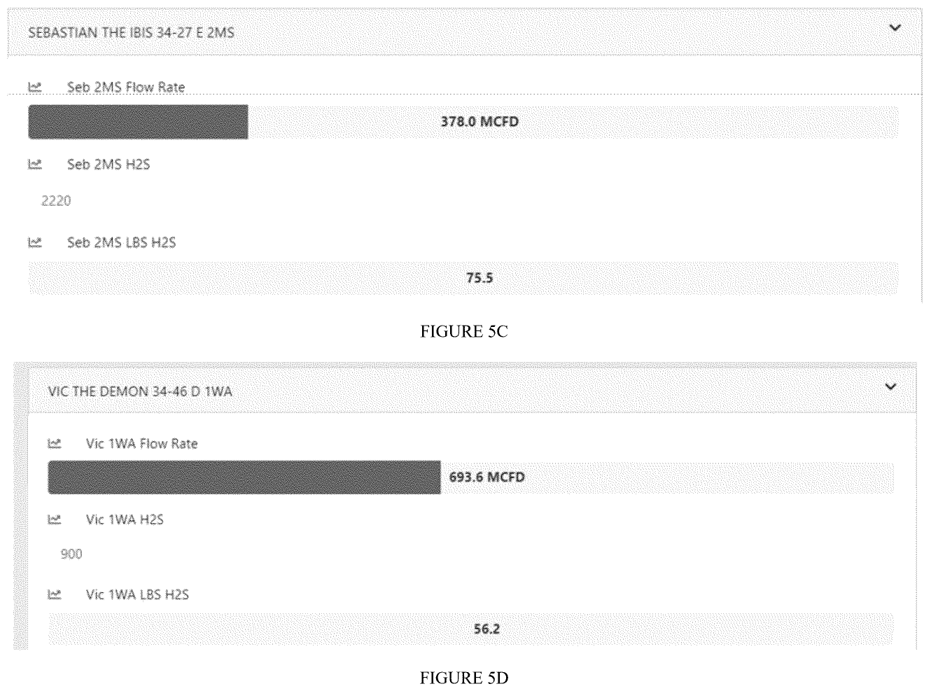

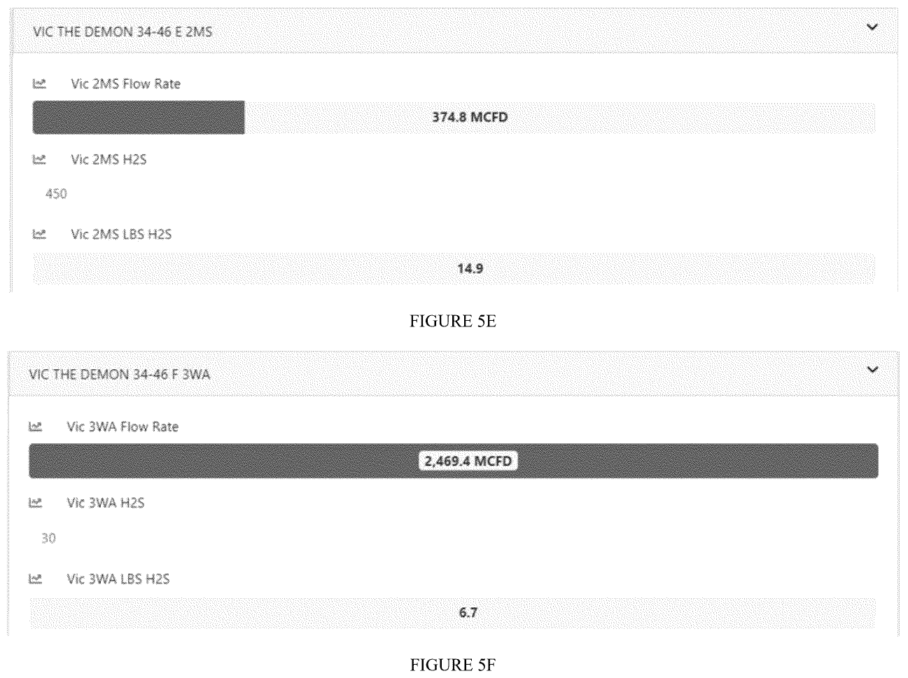

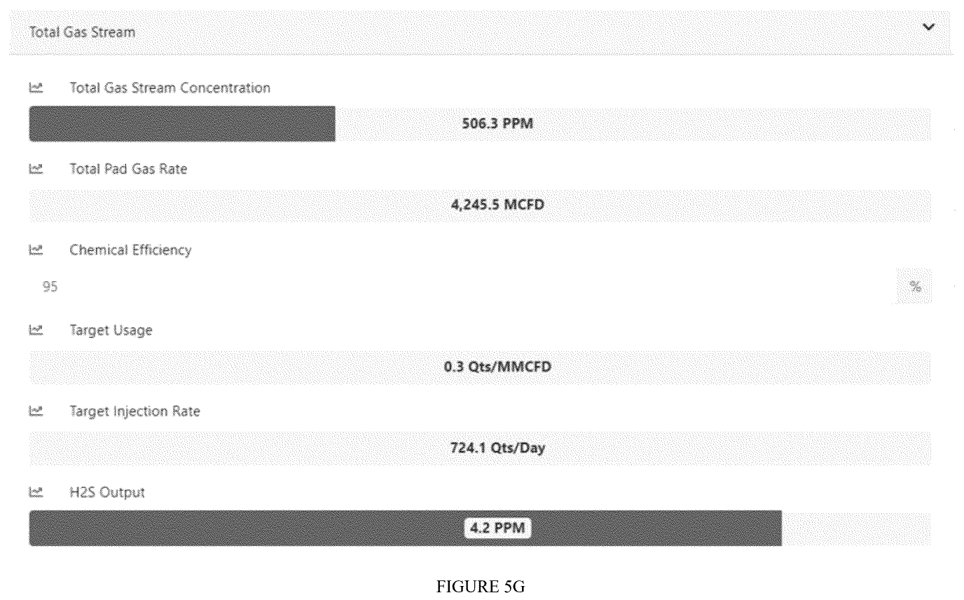

Please refer to FIG. 5A, which shows a snapshot of the real-time monitoring of flow rate and H2S concentration of Well 1. FIGs. In FIG. 5A it is shown that the real-time flow rate is 565.4 MCFD (million cubic feet per day), and the H₂S concentration is set at 5 ppm, or 0.3 lbs. FIGS. 5B-F show the snapshots of real-time monitoring of flow rate and H2S concentrations of five other wells. In FIGS. 5B-F, the flow rates are 520.8 MCFD, 378.0 MCFD, 693.6 MCFD, 374.8 MCFD, and 2469.4 MCFD, respectively. Also in the same figures, the H2S concentraion/amount are 555 ppm/26.0 lbs, 2220 ppm/75.5 lbs, 900 ppm/56.2 lbs, 450 ppm/14.9 lbs, 30 ppm/6.7 lbs, respectively.

The combined gas stream concentration, gas flow rate, chemical efficiency, total usage, target injection rate, and H2S output is shown in FIG. 5G. As calculated by the numbers in FIGS. 5A-F, the combined flow rate at the wellpad is 4245.5 MCFD, with total H₂S concentration in the fluid stream being 506.3 ppm. With these calculated numbers, assuming 95% chemical efficiency, the system then determines a target usage of H2S scavenger of 0.3 Qts/MMCFD, which would arive at an injection rate of 724.1 Qts/day for the H₂S scavenger. The treated combined stream would then have a 4.2ppm H₂S.

Optionally, a post-treatment analyzer can be integrated to spot check the H₂S concentration and ensure the treatment is satisfactory.

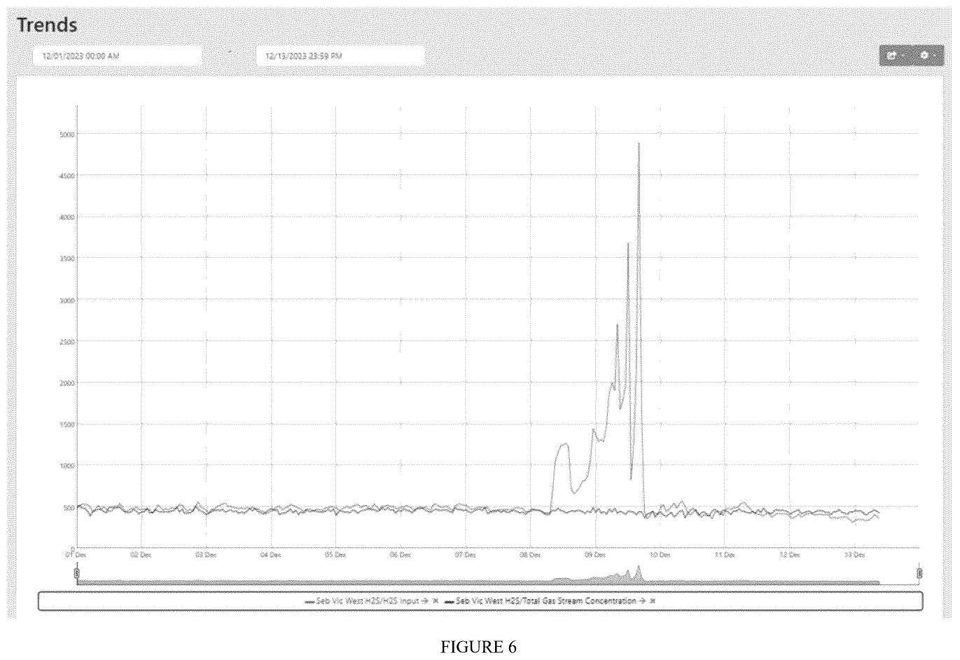

Referring to FIG. 6, which shows a comparison between the necessary amount of H2S scanvenger according to conventional method and the instant disclosure. As shown in FIG. 6, the amount of reagent used spiked significantly between December 6 and December 10, possibly due to a faulty reading of the analyzer that yielded high H₂S concentration in the fluid stream. On the other hand, by using the method of this disclosure to assume constant H2S concentration, the amount of reagent used stays relatively stable. This comparison shows that the amount of reagent can be greatly reduced without wasting due to faulty concentration readings. Additionally, the reduction of reagent also indicates shorter processing time to capture the majority of H₂S.

### Example 2

### Direct Injection Application

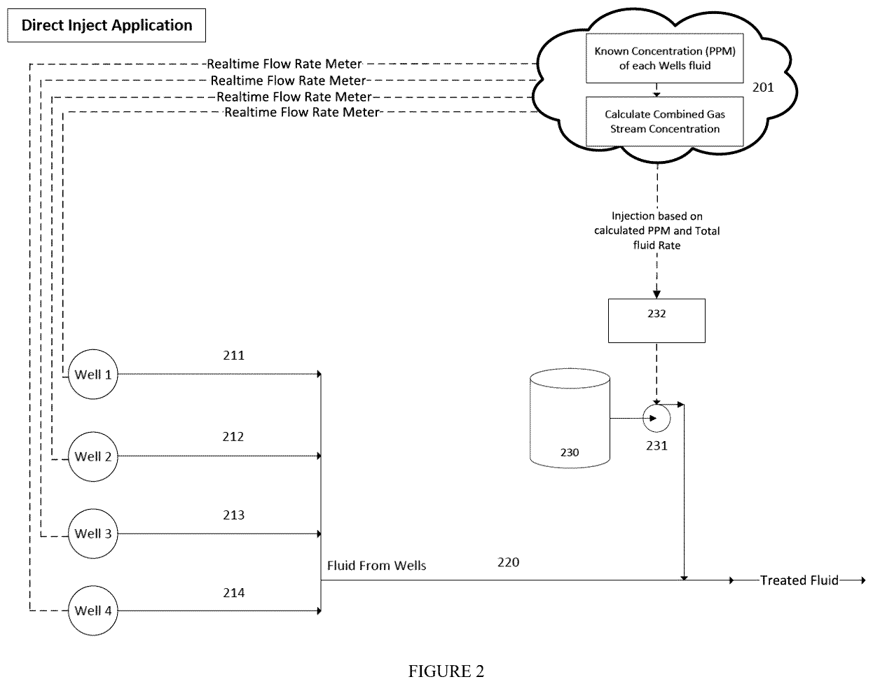

Please refer to FIG. 2, which shows a schematic view of a direct injection application where the elements are similar to FIG. 1 but without using a bubble tower/vessel. As shown in FIG. 2, hydrocarbons produced from wells 1-4 are transmitted through corresponding pipes 211, 212, 213, 214 and converge into a combined fluid stream 220. Similar to the first example, each wellpad is equipped with flow rate meter to measure real-time flow rate of each production well. Also fpr cacj wells a H₂S concentration is known or assumed, thereby removing the need for measuring H₂S concentration. The amount of H₂S in each hydrocarbon stream is calculated by a controller 201.

Once the total amoutn of H₂S is calculated by the summation of from all four wells, the controller 201 can then calculate the amount of H₂S scavenger needed, followed by adjusting the chemical pump actuator 232 to control the release of H₂S scavenger from the tank 230 through the pump 231. Here the H₂S scavenger is directly injected into the combined fluid stream 220 without the use of bubble tower or reation vessel. While the efficiency of removing H₂S from the fluid strem may drop a little, this configuration allows a continuous operation where the amount of H₂S sevenger is adjusted in real-time in response to the change of flow rate at each production well.

### Example 3

### Combined Flow Rate

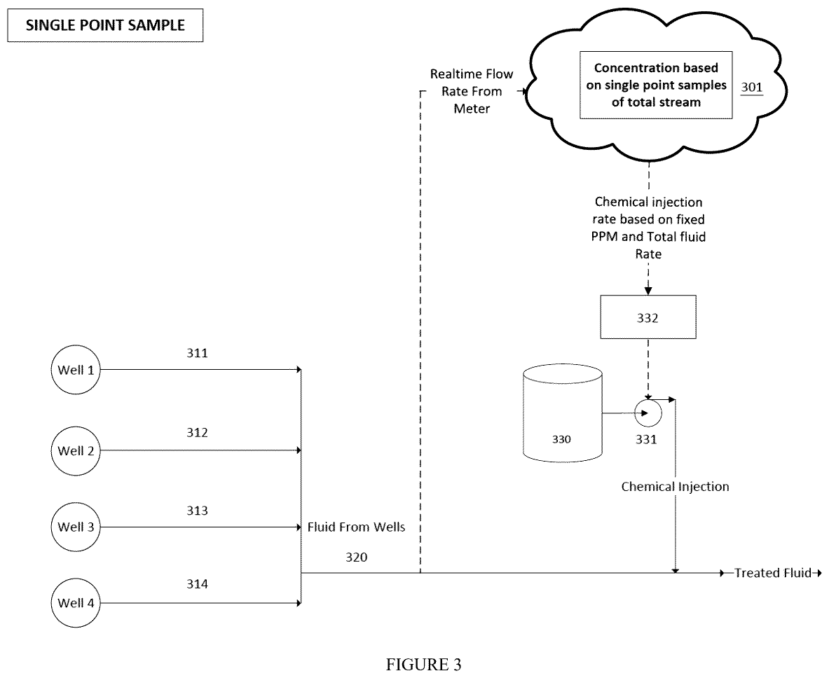

Please refer to FIG. 3, which shows a shematic view of an alternative example. In FIG. 3, the hydrocarbons produced from wells 1-4 311, 312, 313, 314 do not have a flow rate meter integrated. Rather, after all four fluid streams converge, a single point sampling is performed for the combined fluid stream 320 to measure the H₂S concentraion as the baseline number, and the total amount of H₂S is calculated based on this baseline number. The measured concentration is then used as a fix concentration to calculate a total H₂S amount with regard to the combined flow rate. An equivalent amount of H₂S scavenger can then be determined for the flow rate, and the pump actuator 332 is actuated to adjust the injection rate of H₂S scavenger from the tank 330 through the pump 331 and into the combined fluid stream 320. The configuration in this example allows for one single flow rate meter for the combined fluid stream, while requiring only one single point sampling (not shown).

The baseline H₂S concentration need only be measured periodically, for example, once every week or once every two weeks, without having to measure in real time. This not only saves the operation time and cost, but also preserves the analyzer for longer life due to much less wear and tear.

### Example 4

### Measuring from Analyzer

Please refer to FIG. 4, which shows a shematic view of an alternative example where the four fluid sources are combined for one single real-time flow rate measurement. Similar to previous examples, four wells each produces hydrocarbons in fluid sources 411, 412, 413, 414, and the four converges into a combined fluid stream 420. A flow rate meter 421 monitors the real-time flow rate of the combined fluid stream 420. An analyzer 422 is additionally integrated in the system to measure the concentration of a target substance, such as H₂S, CO₂, Oxygen, etc. Once the concentration of the target substance is measured, the controller 401 then calculate the amount of reagent that is required to react with the target substance based on the combined flow rate in stream 420. Based on the calculation, the controller actuates the pump actuator 432, which in turn adjusts the injection rate of the reagent from the reagent tank 430 through the pump 431, into the combined fluid stream 420. If the fluid stream being analyzed is a liquid, samples may be collected for a lab testing to measure its concentration, which can take 10 to 30 minutes to complete. While this is more time consuming, the overall methodology still provides cost saving because the overall savings on materials and time, because the instant method does not require constant measurement of concentration of the liquid stream.

The treated fluid stream can optionally subject to a second analyzer (not shown) to ensure that the reagent adequately reacts with the target substance. If not, the second analyzer sends a feedback signal to the controller for further adjustment to the pump acuatuor 432.

As a general matter, if flow rate of each fluid sorce is to be measured, wellpad flow rate meter would be most ideal, and the choice of flow rate meter would depend on the fluid being produced. For example, in hydrocarbon production wells, oval gear flow meters, turbine flow meters or GF seris gear flow meters may be implemented, as the type of fluid, and their pressure, temperature and viscosity may present different challenges. For gaseous fluid, mass flow meters, velocity flow meters, differential pressure or positive displacement flow meters may be implemented.

In embodiments where the concnetration of the target substance is not measured in real-time, it is the inventor's observation to only periodcally measure the concentration, which is then used as the fixed concentration in calculation. The frequency of measuring may be adjusted based on the fluid source and the consistency of the produced fluid.

In calcuating the amount of target substance, its concentration in the fluid stream and the real-time flow rate are used. If real-time concentration is measured, then the amount of target substance is more accurate. However, for routine bulk operation, a periodically measured concentration is sufficient.

Although in an ideal world it is assumed that the amount of reagent is equivalent to the amount of target substances in the combined fluid stream, in reality there will be a drop in performance. Therefore, a chemical efficiency is considered in the method and system herein, to allow an user to increase or decrease the amount of reagent use accordingly.

Optionally, there can be an algorithm embedded in the controller to actively record the flow rates, concentration, injection rate, efficiency of reaction, and post-treatment concentration of the target substance, so that the algorithm can adjust the injection rate in anticipation of the change in flow rate.

By using the method and system disclosed herein, the inventor was able to reduce the cost of treating H2S by approximately 50%, resulting in significant saving in operation cost. Additionally, the treating efficiency was also improved by 15-20% due to the elimination of concentration measuring.

1. A method of adjusting composition in a fluid stream, the fluid stream comprising fluids from at least a first fluid source and a second fluid source, wherein the fluid stream having a target substance, the method comprising the steps of:
a) measuring a first flow rate of the fluid from the first fluid source;
b) measuring a second flow rate of the fluid from the second fluid source;
c) calculating a combined amount of the target substance in the fluid stream based on the first flow rate and the second flow rate; and
d) adjusting, optionally, an injection rate of a first chemical reagent into the fluid stream.

2. The method of claim 1, further comprising:
a-1) measuring a first concentration of the target substance in the fluid from the first fluid source.

3. The method of claim 1, further comprising:
b-1) meausring a second concentration of the target substance in the fluid from the second fluid source.

4. The method of claim 1, wherein the fluid from the first fluid source having a first concentration of the target substance, and the fluid from the second fluid source having a second concentration of the target substance.

5. The method of claim 1, wherein the fluid from the first fluid source and the second fluid source are hydrocarbons, water or gaseous fluids.

6. The method of claim 5, wherein the first chemical reagent is injected into the fluid stream to react with the target substance in the fluid stream.

7. The method of claim 6, wherein the target substance is H₂S, NOₓ, SOₓ, CO, CO₂ or O₂.

8. The method of claim 7, wherein the first chemical reagent is MEA triazine, non-triazine scavengers, sodium hydroxide caustic scavengers, or sodium nitrate caustic scavengers.

9. A method of adjusting composition in a fluid stream, the liquid stream comprising fluids from at least a first fluid source and a second fluid source, and both fluid sources combine into a fluid stream having a target substance, the method comprising the steps of:
a) measuring a flow rate of the combined fluid stream;
b) optionally measuring a concentration of the target substance in the combined fluid stream; and
c) adjusting an injection rate of a first chemical reagent into the fluid stream based on a calculation of the equivalent amount of the first chemical reagent necessary to react with the target substance.

10. The mehtod of claim 9, wherein the step b) is performed periodically over a predetermined period of time.

11. The method of claim 9, wherein the step b) is performed in real-time.

12. The method of claim 9, further comprising the step of:
d) measuring the concentration of the target substance in the fluid stream after step c).

13. A system for capturing a target substance in a fluid stream in a main pipeline, wherein the fluid stream comprises at least a first fluid source and a second fluid source, the system comprising:
a) a first pipeline fluidically connecting the first fluid source to the main pipeline;
b) a second pipeline fluidically connecting the second fluid source to the main pipeline;
c) a first tank storing a first chemical reagent and fluidically connected to the main pipeline, wherein a pump is operatively connected to the first tank to controlls the first tank;
d) a controller operatively coupled to the pump to control the actuation of the pump; and
e) at least one flow rate meter, wherein the flow rate meter is configured to measure the flow rate in the main pipeline or the flow rate in the first pipeline and the second pipeline;
f) wherein the controller optionally actuates the pump, based on a calculated concentration of a target substance in the fluid stream in the main pipeline, to inject the first chemical reagent from the first tank to the main pipeline, wherein the first chemical reagent reacts with the target substance.

14. The system of claim 13, further comprising a treating vessel fluidically connected to the main pipeline and the first tank, and wherein the first chemical reagent is introduced into the treating vessel to react with the target substance in the fluid stream.

15. The system of claim 13, wherein the first chemical reagent is introduced directly into the main pipeline to reacts with the target substance of the fluid stream.

16. The system of claim 13, further comprising a first analyzer measuring concentration of the target substance.

17. The system of claim 16, wherein the first analyzer measures the concentration of the target substance in the main pipeline upstream of the injection of the first chemical reagent.

18. The system of claim 13, further comprising a second analyzer measuring concentration of the target substance downstream of the inejction of the first chemical reagent.

19. The system of claim 13, further comprising a second tank storing a second chemical and fluidically connected to the main pipeline.

20. The system of claim 13, wherein the calculated concentration of the target substance is calculated by a programmable logic controller (PLC) or a supervisory control and data acquisition (SCADA).
